(19) United States
(12) Patent Application Publication
(10) Pub. No.: US 2003/0125962 A1
(43) Pub. Date: Jul. 3, 2003

(54) System and process for measurement of delivery of products and services to customers

(76) Inventors: Steven Holliday, Richmond, VA (US); Gerald Larkin, Glen Allen, VA (US); Paul Shager, Lynchburg, VA (US); Suzy LeSage, Napa, CA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/028,309

(22) Filed: Dec. 28, 2001

(51) Int. Cl. G06F 17/60

(52) U.S. Cl. 705/1

(57) ABSTRACT

A system and process for evaluating a business entity's success in developing new business. The process includes the steps of developing a strategy and a plan to support at least one of the business entity's high level objectives in a component of the business entity; establishing a relationship between the component of the business entity and an intermediary using the developed plan; enabling a relationship between the component of the business entity and a producer using the developed plan; establishing a relationship between the component of the business entity and a consumer using the developed plan; and processing new business resulting from the established relationship between the component of the business entity and the consumer.

### FIELD OF THE INVENTION

The invention relates generally to a business development process, and, more particularly, to a process for uniformly developing and managing new business within a business entity and for measurement of performance factors in connection with an entity's business development processes.

### BACKGROUND OF THE INVENTION

A primary objective of any business entity is to develop new business from new customers in order to increase its revenues. Thus, typically a business entity will spend significant time developing a strategic plan to target potential new customers and to then implement sales initiatives to generate business from the targeted potential new customers.

However, many business entities do not have an effective means for measuring and evaluating their success, or lack thereof, in realizing these new business generation objectives. Such problems may be enhanced by factors such as selling into different trade channels or to different types of targeted customers (i.e., direct-to-consumer; sales via agents or brokers; sales via the Internet; sales to other business entities). Additionally, many business entities do not have an effective means to evaluate whether they generate new sales because of increased advertising or by referrals from other customers or via other means.

Other drawbacks in connection with conventional new business development processes may also exist.

### SUMMARY OF THE INVENTION

It is therefore desirable to address the drawbacks referenced above.

A system and process for evaluating a business entity's success in developing new business is described. The process comprises the steps of developing a strategy and a plan to support at least one of the business entity's objectives in a component of the business entity; establishing a relationship between the component of the business entity and an intermediary using the developed plan; enabling a relationship between the component of the business entity and a producer using the developed plan; establishing a relationship between the component of the business entity and a consumer using the developed plan; and processing new business resulting from the established relationship between the component of the business entity and the consumer. The step of developing the strategy and the plan may include developing the strategy and the plan to support the business entity's high level objectives.

According to one aspect of the invention, the process may be performed in a deliver solutions module of the overall process for the component of the business entity.

According to another aspect of the invention, the success of the process may be evaluated using a plurality of dashboards including a business to business dashboard, a business to producer dashboard, a business to consumer dashboard and a new business dashboard.

According to yet another aspect of the invention, the success of the process may be evaluated by measuring a throughput, a timeliness, a yield, and/or a cost of each of the steps of the process.

The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a block diagram illustrating one embodiment of a business entity of the present invention;

FIG. 2 is a schematic representation of a system for implementing one embodiment of the process of the present invention;

FIG. 3 is a flow diagram illustrating the steps performed in one embodiment of a process for delivery of new business in a component of a business entity;

FIG. 4 is a flow diagram illustrating the steps performed in one embodiment of a process for developing a strategy and a plan for development of new business in a component of a business entity;

FIG. 5 is a flow diagram illustrating the steps performed in one embodiment of a process for establishing a relationship with in an intermediary component of a business entity;

FIG. 6 is a block diagram illustrating one embodiment of a process for enabling a relationship with a producer in a component of a business entity;

FIG. 7 is a flow diagram illustrating the steps performed in one embodiment of a process for establishing a relationship with a consumer in a component of a business entity; and

FIG. 8 is a flow diagram illustrating the steps performed in one embodiment of a process for processing new business in a component of a business entity.

### DETAILED DESCRIPTION OF THE INVENTION

Reference will now be made in detail to the present preferred embodiments of the invention, examples of which are illustrated in the accompanying drawings in which like reference characters refer to corresponding elements.

The present invention is described in relation to systems and processes for delivering solutions for transaction requests for financial services in a business entity. Nonetheless, the characteristics and parameters pertaining to the systems and methods may be applicable to other types of businesses and transaction requests for other services including transaction requests for e-commerce based services, for example.

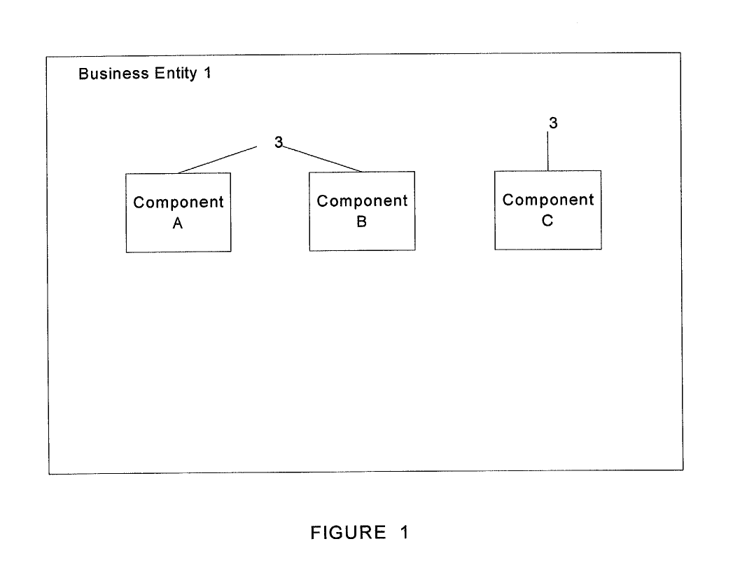

FIG. 1 is a block diagram illustrating one embodiment of a business entity 1. The business entity 1 may include a plurality of components 3. The components 3 may be comprised of other acquired business entities 1 or departments within the business entity 1. In one embodiment, the business entity 1 may be a financial services company. The components 3 may include a plurality of different financial services companies acquired by the business entity 1. For example, the components 3 may include companies selling insurance products, accounting services, or e-commerce services. The components 3 may sell a number of different products with different features.

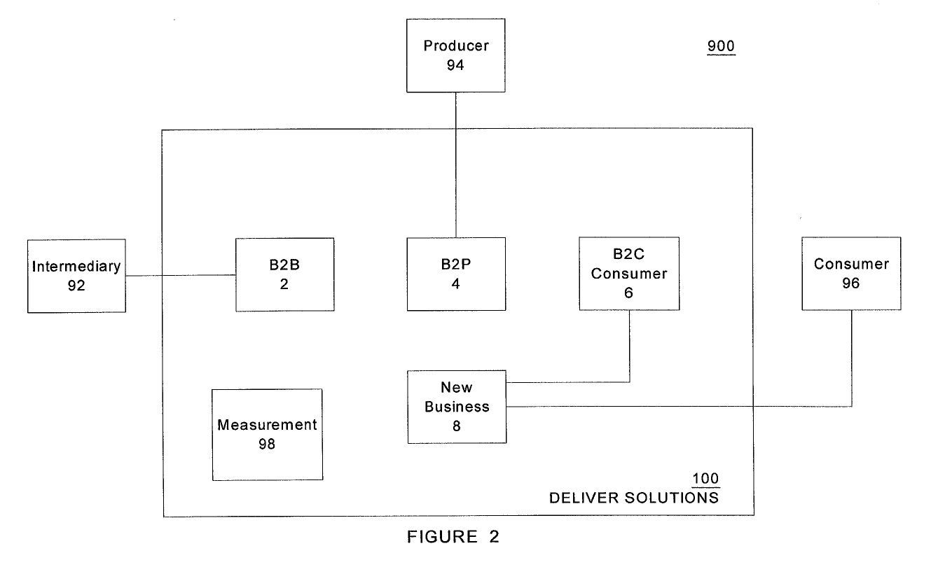

FIG. 2 is a schematic representation of a system 900 for implementing an embodiment of the invention. The system 900 includes a deliver solutions module 100, an intermediary 92 (such as a broker or an agent), a producer 94, and a consumer 96.

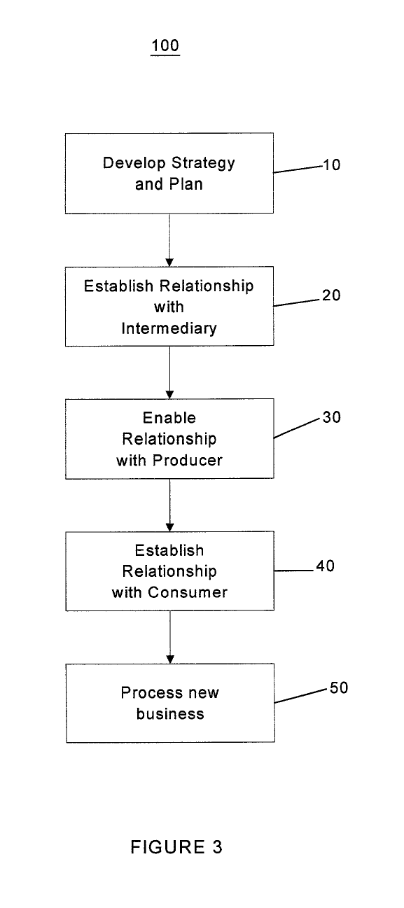

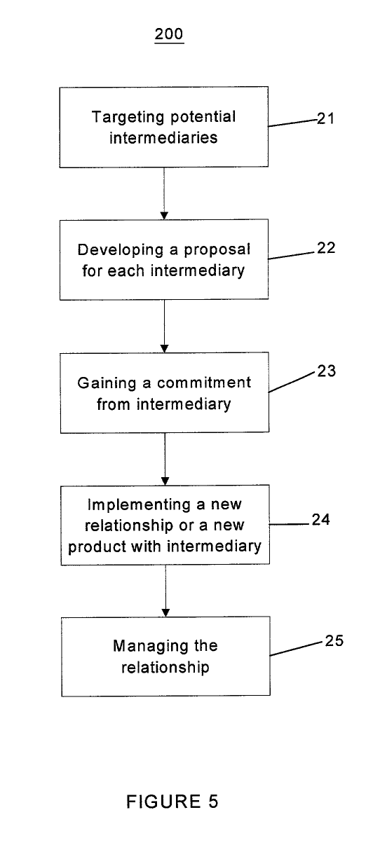

The deliver solutions module 100 is a part of an overall process for operating a component 3 of the business entity 1. The deliver solutions module 100 includes a plurality of dashboards 2, 4, 6 and 8 and a measurement module 98. The dashboards 2, 4, 6 and 8 may include a business-to-business (“B2B”) dashboard 2, a business-to-producer (“B2P”) dashboard 4, a business-to-consumer (“B2C”) dashboard 6, and a new business dashboard 8. The dashboards 2, 4 and 6 are used to monitor and measure results of a B2B process, a B2P process, and a B2C process, respectively, and how the business entity 1 delivers products and/or services to its various classes of customers (i.e., Business customers, Producer customers and Consumer customers). The B2B dashboard 2 may be used to measure sales and relationships with other business firms, such as the intermediary 92. In one embodiment, the B2B dashboard 2 may be used to measure the business entity 1's ability to gain access to customers of the intermediary 92. Only one intermediary 92 is shown for simplicity. In practice, relationships with as many intermediaries 92 as desired may be measured. The processes for managing the business entity 1's B2B relationships will be described below with reference to FIGS. 3 and 5.

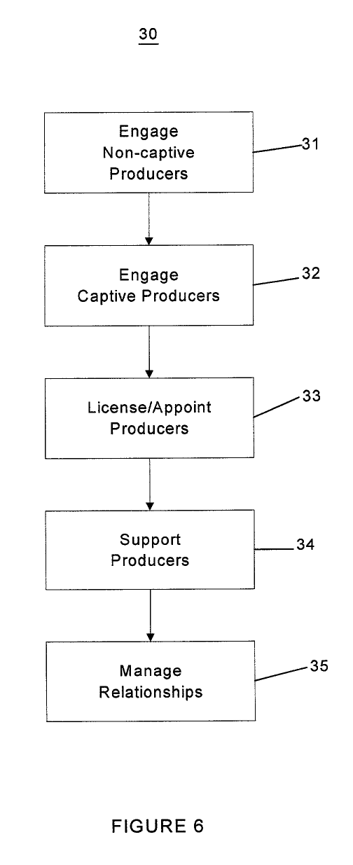

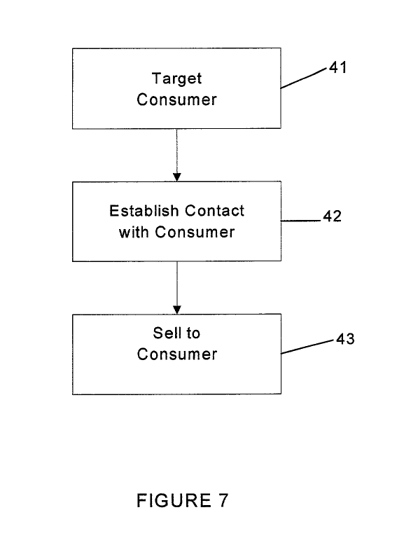

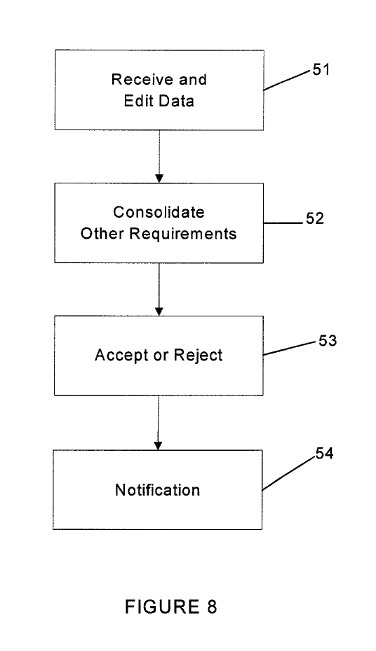

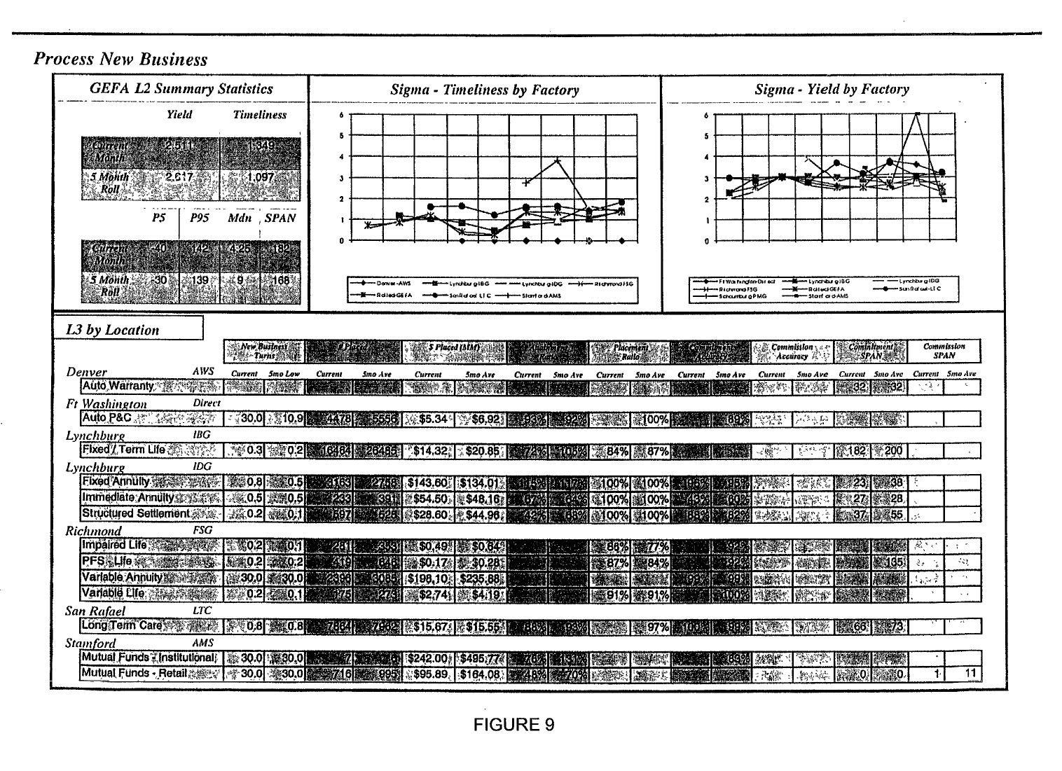

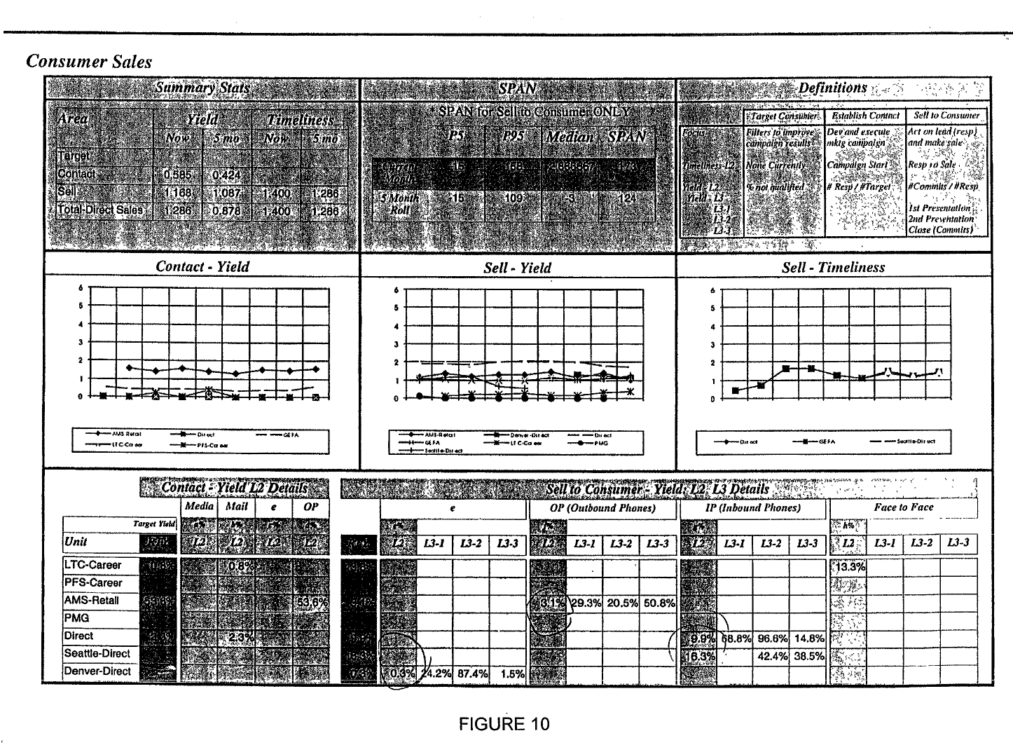

The B2P dashboard 4 may be used to measure sales and relationship processes of the business entity 1 with producers, such as the producer 94, as described below with reference to FIGS. 3 and 6. The B2C dashboard 6 may be used to measure sales and relationship processes of the business entity 1 with consumers, such as the consumer 96, as described below with reference to FIGS. 3 and 7. Only one producer 94 and one consumer 96 are shown for simplicity. In practice, relationships with as many producers 94 and consumers 96 as desired may be measured. The new business dashboard 8 may be used to measure product/service fulfillment processes, as described below with reference to FIGS. 3 and 8.

The measurement module 98 may be a part of the deliver solutions module 100. The measurement module 98 may be used to evaluate performance in connection with the processes described below with reference to FIGS. 5-8. In one embodiment, the measurement module 98 may be used in connection with each of the dashboards 2, 4, 6 and 8 and may perform evaluations specific to each process described below with reference to FIGS. 3-8.

In one embodiment, the deliver solutions module 100 may be part of a computer software package or a web site. Each of the dashboards 2, 4, 6 and 8 may represent a single web page or the content of a single screen in a software program. Although the measurement module 98 and the dashboards 2, 4, 6 and 8 are shown to reside inside the deliver solutions module 100, in one embodiment, the measurement module 98 and dashboards 2, 4, 6, 8 may reside outside the deliver solutions module 100. The processes measured by each functions of the dashboards 2, 4, 6, 8 will be described below with reference to FIGS. 3-8.

FIG. 3 is a flow diagram illustrating the steps performed by the business entity 1 in a new business development process 100. As shown in FIG. 3, at step 10, a component 3 of a business entity 1 may develop a strategy and a plan for targeting new business. Step 10 may conclude with an output of a developed plan for the component 3.

At step 20, the component 3 may establish a B2B relationship with an intermediary 92 if an intermediary relationship is desired. For example, the business entity 1 may desire a relationship with another firm to gain access to the other firm's customers. The success of step 20 may be measured using the B2B dashboard 2. In one embodiment, an input to the B2B process of step 20 may include the developed plan that is the output of step 10. The output of the B2B process of step 20 may include an established relationship with the intermediary 92.

At step 30, the component 3 may enable a relationship with a producer 94. Step 30 may incorporate of all the activity done on behalf of the “physical” producer 94 in order to prepare the producer 94 to better enable the producer 94 to sell the business entity 1's product. The success of step 30 may be evaluated or measured using the B2P dashboard 4. In one embodiment, an input to the B2P process of step 30 may include a step of capacity planning. An output of the B2P process of step 30 may include a managed performance of the enabled producer 94.

At step 40, the component 3 may establish a relationship with a consumer 96. In one embodiment, the consumer 96 may be a purchaser of products of the component entity 3. The success of step 40 may be evaluated or measured using the B2C dashboard 6. In one embodiment, an input to the B2C process of step 40 may include the developed plan that is the output of step 10. An output of the B2C process of step 40 may include a decision of the consumer 96 concerning whether to purchase a product from the component 3.

At step 50, the component 3 may process new business resulting from the execution of steps 10, 20, 30 and 40. In one embodiment, step 50 may include putting a purchase commitment from the consumer 96 into force and collecting revenues. The processing of new business performed in step 50 may be measured using the new business dashboard 8. In one embodiment, an input to the new business process of step 50 may include the consumer 96's decision that is the output of the B2C process of step 40. An output of the new business process of step 50 may include the received purchase commitment from the consumer 96. The sequence of steps shown in FIG. 3 may be modified in accordance with the present invention. The steps illustrated in FIG. 3 will now be described in greater detail.

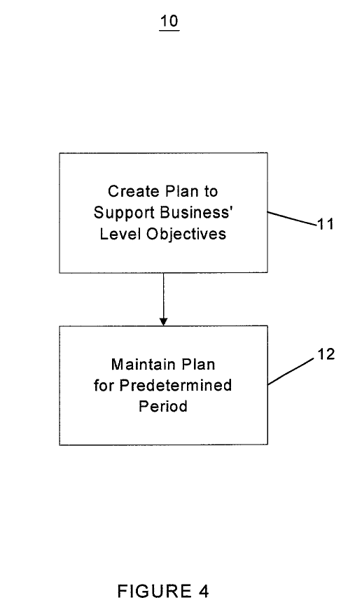

At step 10, the component 3 of the business entity 1 develops the strategy and a plan for development of new business. FIG. 4 is a flow diagram illustrating one embodiment of a process for developing the strategy and the plan in the deliver solutions module 100. As shown in FIG. 4, at step 11, the component 3 may develop the plan to support the business entity 1's high level objectives. At step 12, the component 3 maintains the developed plan for a predetermined period of time.

The step 11 of developing the plan may include a strategic and a high-level tactical business planning process. The step 11 of developing the plan may also include performing a preparatory review. The step 11 of developing the plan may further include the sub-steps of proposing a plurality of goals, mapping the goals to the business entity 1's goals and developing strategies aligned with the goals proposed. For example, if the business entity 1 is a financial services company, the component 3 of such financial services company may be an insurance company. Thus, the insurance company component 3 may propose goals for developing new business and map the goals to financial services company 1's goals. The insurance company component 3 may then develop strategies aligned to the mapped goals.

In one embodiment, the step 11 of developing the plan may include developing at least one tactical plan based on the strategies developed. The component company 3 may then confirm whether it has a capacity to perform the tactical plan or plans, develop financial projections for the tactical plan(s) and communicate the plan(s) to marketing/sales channels and factories affiliated with the business entity's products.

In one embodiment, the step 11 of developing the plan may include ratifying the developed plan with stakeholders of the business entity 1. In one embodiment, the step 11 of developing the plan to support the business entity's high level objectives may include creating a periodic plan, such as an annual plan.

The step 12 of maintaining the developed plan for a predetermined period of time may include maintaining the developed plan for a year. The step 12 of maintaining the developed plan may also include updating the developed plan as necessary or desired throughout the predetermined period.

With reference to FIG. 3, at step 20, the component 3 may establish a relationship with an intermediary business entity if an intermediary relationship is desired. The component 3 may establish relationships with other firms to gain access to the other firms' customers. The success of the step 20 of establishing a relationship with an intermediary may be measured or evaluated using the B2B dashboard 2. The B2B dashboard 2 may focus on B2B selling steps and B2B relationship management vitals. Persons within the business entity 1's or the component 3's organizations who will be responsible for implementation of step 20 may include sales and relationship managers. The step 20 functions may include identifying potential partners, signing up potential partners or gaining a commitment to the relationship from a potential partner, and maintaining goodwill within the relationship.

The functions performed in step 20 are illustrated in greater detail in FIG. 5. FIG. 5 is a flow diagram illustrating the steps performed in one embodiment of a method 200 for establishing a relationship with an intermediary 92. At step 21, the component 3 may target at least one potential intermediary 92. The step 21 of targeting potential intermediaries 92 may include assessing a universe of potential intermediaries 92 and selecting target entities from the assessed potential intermediaries 92. The targeting step 21 may also include contacting the target entities.

At step 22, the component 3 may develop a proposal for establishing a relationship with each intermediary 92 targeted. At step 23, the component 3 may gain a commitment from at least one of the target intermediaries 92. At step 24, the component 3 may implement a new relationship with each of the committed target intermediaries 92 if a previous relationship with a committed target intermediary 92 does not exist. In one embodiment, the component 3 may sell a new product to a committed target intermediary 92 if a previous relationship exists between the component 3 and the committed target intermediary 92. At step 25, the component 3 may manage the relationship with each of the committed target intermediaries 92. Thus, the step 20 of establishing a relationship with an intermediary 92 may include targeting intermediaries, signing and implementing the relationships with committed target intermediaries, selling new products to committed target intermediaries, as well as conducting activities sponsored at the firm level for goodwill.

In one embodiment, the process of FIG. 3 may further include a step of evaluating new business developed in the component 3. The step of evaluating the new business developed may include measuring a throughput, a timeliness, a yield and a cost of the new business development process. The throughput may include the products delivered to a new customer. The timeliness may include the speed at which a new product is delivered in relation to customer expectation. The yield may include the rate at which targeted new business becomes a business commitment. And, the cost may include the amount of money spent to generate new business. In one embodiment, the steps of evaluating the success of the new business process may be accomplished by using each of the dashboards 2, 4, 6 and 8.

The success of the B2B new business development process may be evaluated by measuring a timeliness, a yield, and a cost of the establishment of the B2B relationship in step 20. The timeliness measurement of the B2B process may include measurement of a first proposal turn, a final disposition turn and B2B relationship timeliness. The first proposal turn may be measured by measuring a number of first proposals generated resulting in new business in relation to the number of first proposals still in the process. The final disposition turn may be measured by measuring a number of final dispositions in relation to a number of deals in progress. Relationship timeliness may be measured by an actual time span for implementing the new business relationship vs. a time span defined by a contracted date for implementing the new business relationship, or after “lock in” or a commitment from the customer, where specified. With reference to FIG. 5, assessing the yield may include measuring a response ratio at a contact target step 21, a first proposal success ratio at a developed proposal step 22, a closing ratio at the gaining a commitment step 23, a production ratio at the implementing a relationship step 24 and a sales production level and a penetration level at the managing the relationships step 25.

The response ratio may be measured by counting a number of positive responses in relation to a number of prioritized business targets identified in step 21. A first proposal success ratio may be measured by measuring a number of first proposals which generated interested business customers in relation to a total number of first proposals. A B2B close ratio may include measuring a number of B2B deals closed in relation to a number of B2B opportunities identified. The B2B production (or sales) ratio may include measuring an amount of revenue from closed B2B deals in relation to an amount of B2B revenue projected in the developed plan. The B2B sales production measurement may include B2B sales to firms with consumer customers and firm level B2B sales.

In the B2B firms with consumer customers, B2C sales production may be measured by an amount of sales production dollars spent vs. a planned amount of sales production dollars. For firm level sales, B2B retention may be measured by counting a number of closed B2B accounts during a preceding accounting period in relation to the number of B2B accounts at the start of the preceding accounting period. Sales penetration may be measured in relation to the sales penetration projected in the developed plan.

Measuring costs may include measuring a firm expense ratio. Measuring costs may also include measuring a plurality of managers' salaries, a time and an expense of establishing the B2B relationship, a cost of conducting due diligence meetings, a cost of conducting firm level education, and a cost of “pay to play”. Measuring costs of generating sales helps determine a sales return or “value” of a new business relationship.

With reference again to FIG. 3, at step 30, the component 3 may enable a relationship with a producer 94. The success of the enabling step 30 may be measured using the B2P dashboard 4. The B2P dashboard 4 may focus on processes that identify target producers 94, sign targeted producers 94 to commitments, train signed producers 94 on sales processes, license/appoint the signed trained producers 94, and support the licensed producers 94 to help the business entity 1 meet sales production targets. “Process owners” (i.e., personnel of the business entity 1 or the component 3 having responsibility over the enabling step 30) may include regional/area sales managers.

The enabling step 30 may include a tactical level deployment of a business plan, an execution and a ramp up of a non-captive producer 94 and a captive producer 94 and their supporting new business development plans (where a non-captive producer 94 refers to a producer 94 that is not contractually bound to sell the business entity 1's products exclusively versus a “captive” producer 94 who is so contractually bound) and also implementation of supporting functions and projects aimed at improving sales effectiveness. Sales effectiveness is a measure of how effectively a producer 94 maximized new business returns based on expended resources. Sales effectiveness factors may include a timeliness, a yield, an efficiency, a throughput and a compliance level. The enabling step 30 may further link a sales planning step to a sales execution step, and leverage the tools and processes developed by supporting functions on behalf of the producer 94.

FIG. 6 is a flow diagram illustrating one embodiment of the sub-steps performed in step 30 for enabling a B2P relationship of FIG. 3. At step 31, the component 3 may engage at least one non-captive producer to sell a product for the business entity 1. In one embodiment, the non-captive producer may include a producer that does not have a prior contractual commitment to the component 3.

At step 32, the component 3 may engage a captive producer to sell a product for the business entity 1. The captive producer may be a producer that has an existing contractual commitment to the business entity 1 or to the component 3. For new producer relationships, at step 33, the component 3 insures appropriate licensing and appointment for each of the engaged producers and that any other statutory obligations are satisfied. At step 34, the component 3 may perform supporting activities to improve the effectiveness of each of the licensed and appointed producers including, for example, answering questions, providing sales literature and sales tips, etc.

The B2P dashboard 4 may be used to measure supporting functions such as a timeliness, a yield and a cost of enabling the B2P relationship. The timeliness component for the B2P processes on the B2P dashboard 4 may include a measure of the ability to fill open captive producer positions, the speed with which statutory licensing and appointment obligations are satisfied, and other speed metrics around supporting activities. In one embodiment, captive producer staffing may be measured in relation to engaging captive producers 32. In one embodiment, captive producer staffing measurements may include measuring open position turns or staffing cycle time. The number of turns may be measured by a number of positions filled in relation to a number of positions opened. The staffing cycle times may be measured by measuring the time from when a staffing need was identified to a time when the open position was filled.

Notification cycle times may be measured in relation to the step 33 of licensing and appointing a producer. The notification cycle time may be measured by measuring the time from the licensing/appointment request to the notification of completion of statutory licensing and appointment obligations. A speed of answer and a resolution cycle time may be measured during the support producer step 34. The speed of answer may be measured in relation to all incoming calls received through automated switches. In one embodiment, the speed of answer may be measured from an interactive voice response selection to the answer. The resolution cycle time may be measured in relation to all support requests received. In one embodiment, the resolution cycle time may be measured from a time of a first call to a time of resolution and closure with the originator of the first call.

The yields may be measured by measuring a non-captive production, a non-captive penetration, a captive production, a captive retention, an abandon rate and a first inquiry resolution rate. The non-captive production and the non-captive penetration may be measured in relation to the step 31 of engaging a non-captive producer. In one embodiment, the non-captive production may be measured in relation to sales produced by a regional manager vs. the projected sales in the new business development plan. In one embodiment, non-captive penetration may be measured by the number of producers selling in relation to the number of producers able to sell. In another embodiment, the number of producers able to sell may be comprised of the number of producers licensed and appointed.

The captive production and the captive retention may be measured in relation to the step 32 of engaging captive producers. The captive production may be measured in relation to the sales produced by a regional manager vs. the projected sales in the new business development plan. The captive retention may be measured by measuring the number of producer terminations in a period in relation to the number of producers retained at the beginning of the period.

The abandon rate and the first inquiry resolution rate may be measured in the support producers step 34. In one embodiment, the abandon rate may be measured by measuring the number of incoming calls abandoned before being answered in relation to the total number of calls tendered. In one embodiment, the first inquiry resolution rate may be measured by measuring the number of inquiries resolved on the first inquiry in relation to the total number of inquiries.

The steps of measuring cost using the B2P dashboard 4 may include measuring an enabling expense ratio. The step of measuring cost may also include measuring a plurality of salaries and bonuses paid to internal sales leaders, a plurality of bonuses paid to external non-employee agents and/or brokers, a time and an expense of enabling the B2P relationship, a cost of producer education, a cost of development and distribution of marketing materials, a cost of home office phone support for field producers, a cost of license and appointment resources and fees and a cost of technology and automation tools.

At step 40 of FIG. 3, the component 3 may establish a relationship with a consumer. The step 40 of establishing a relationship with a consumer may be a part of the B2C new business development process. The B2C new business development process may focus on marketing or demand generation and sales processes that can convert consumer level interest into commitments to purchase products.

FIG. 7 is a block diagram illustrating the steps performed in one embodiment of a process for establishing of a relationship between a component 3 and a consumer. At step 41, the component 3 may target at least one consumer. At step 42, the component may establish contact with the consumer. At step 43, the component 3 may sell a product to the consumer.

The step 41 of targeting a consumer may represent a first stage of a marketing campaign. In one embodiment, the product(s) to be marketed may be market ready and high-level consumer profiles may already have been compiled. The objective of the targeting a consumer step 41 will be to focus the efforts of the marketing campaign on a subset of the objective population in order to reduce waste. This step 41 may include identifying a source of consumers, such as marketing lists, etc. The step may further include developing models with filtering criteria such as stratification/segmentation criteria for targeting consumers. The models may be applied to the marketing lists or other sources of consumers. The component 3 may then generate a listing including at least one targeted consumer based on the application of the models to the source of the consumers.

Once the target population has been identified, compliant materials may be created or chosen that communicate the offer to the potential customers through some form of media. The media may include mail, phone, internet, kiosk, etc. Thus, the component 3 may establish contact with a consumer at step 42 and an offer to sell a product. The output of the step 42 may be a positive response to the offer. In one embodiment, the step 42 of establishing contact may include campaign planning, execution and tracking. In another embodiment, the step 42 of establishing contact may include developing or choosing campaign specific marketing materials and delivering the sales offer via phone, web, e-mail or other means.

In yet another embodiment, the step 42 of establishing contact with the consumer may include developing marketing tools to contact the consumer and preparing to contact the consumer by developing and choosing specific marketing materials. The step 42 of establishing contact may further include a sub-step of initiating contact with a consumer. In one embodiment, the sub-step of initiating contact with a consumer may include delivering a sales offer to the consumer.

A positive consumer response or sales lead may begin the sales process at step 43. In one embodiment, an invisible producer, such as a producer using the web or a mail method of selling, may be used. In another embodiment, a physical producer, such as a producer using a phone or an in-person method of selling, may be used. The producer may assess the consumer's product needs and present a product meeting such needs. The step 43 may end with a commitment from the consumer to buy, a decline of the sales offer, or a delay in making a purchase decision. The direct results of step 43 may be a revenue producing sales transaction. The step 43 of selling to the consumer may include making a consumer contact after a positive consumer response, conducting a consumer needs assessment, conducting a sales presentation to the consumer, and completing an application, a contract or a sales commitment. The step 43 of selling to the consumer may also include an assessment of all of the resources consumed in the direct sale. The resources may include costs relating to travel, communications and sales materials.

In one embodiment, the step 43 of selling to the consumer may include following through on a contact established with a consumer, determining the needs of the consumer, and matching the needs of the consumer to an available product. The step 43 of selling to the consumer may further include delivering a sales presentation to the consumer and closing the deal between the component entity 3 and the consumer. In one embodiment, following through on a contact may comprise setting up an appointment with a consumer.

At step 50, the component entity 3 may effect a fulfillment of new business through fulfillment of the B2B relationship, the B2P relationship and the B2C relationship. The new business dashboard 8 may be used to measure the effectiveness of fulfillment of new business. The new business dashboard 8 may focus on product fulfillment and commission delivery processes.

In one embodiment, a commitment from the consumer may be measured by revenues collected as a result of the new business. A process of selection may be used to screen unacceptable input. Business may be placed after selection, when the revenues may be formally recognized, putting the products in force.

The consumer sales dashboard 6 may be used to evaluate the results of the B2C process. The factors which may be considered in such evaluation may include a timeliness, a yield, and a cost of the establishment of the B2C relationship. Measuring the timeliness may include measuring a sales campaign timeliness, a sales cycle time, a first presentation, a second presentation, and a close. The campaign timeliness may be measured during the step 42 of establishing a contact. The campaign timeliness may be measured by measuring the number of days that a sales campaign start date deviates from a planned start date.

The sales cycle time, the first presentation, the second presentation and the close may be measured in step 43 of selling to the consumer. The sales cycle time may include measuring a time from a positive response to an outcome (i.e., a decision to buy, decline or delay). Targets may be established based upon a selling mode (i.e., face-to-face, telephone solicitation, etc.) and a product. The first presentation may include measuring the time from a positive response to a first contact. The second presentation may include measuring the time from the first presentation to the second presentation. Measuring the close timeliness may include measuring the time from the second presentation to the closing or disposition.

The consumer sales dashboard 6 may be used to measure yield for the B2C sales process. Factors which may be measured include a response ratio, a sales success ratio, a first presentation ratio, a second presentation ratio and a close ratio. The response ratio may be measured in the establishing contact step 42. In one embodiment, the response ratio may be measured by measuring the number of positive responses received in relation to the number of consumers targeted.

The sales success ratio, the first presentation ratio, the second presentation ratio and the close ratio may be measured during the selling to consumer step 43. The sales success ratio may be measured by measuring the number of commitments received in relation to the number of positive responses received. The first presentation ratio may be measured by measuring the number of first presentation opportunities in relation to the number of positive responses received. The second presentation ratio may be measured by measuring the number of second presentation opportunities in relation to the number of first presentations. The close ratio may include the number of commitments received in relation to the number of second presentations.

In one embodiment, the step of measuring the yield may also include measuring the number of “do not quotes” in relation to a number of positive responses received, the proportion of positive responses received to the total targeted population, and the number of successes moving through major process steps in relation to the inputs into that step.

The step of measuring costs of the B2C sales process may include measuring the cost related to obtaining sources of consumers such as a cost of purchasing lists of names of prospective consumers, costs related to an effort to develop and apply filters, a cost per response, and a cost per sale. In one embodiment, costs may include the cost of design of a sales campaign and marketing materials, preparation for contact, and the cost of contact, including bulk mail, phone, internet, etc. In one embodiment, costs may include, in the selling to consumer step 43, direct selling expenses, salaries and wages of sales producers, not including commissions but including bonuses, time and expense of any marketing materials consumed by sales, and communication costs incurred in sales.

The step 50 of processing the new business may include application processing, case management, underwriting, medical or other requirements, issue and delivery, a notification, revenue collection and account reconciliation.

FIG. 8 is a flow diagram illustrating the steps performed in one embodiment of a process for processing new business. At step 51, a component 3 may receive and enter data related to a sale of a product to a commercial customer or a consumer. At step 52, the component 3 may consolidate a plurality of results of other requirements to assess risk and comply with business risk objectives.

At step 53, the component 3 may accept or reject the sale based upon an outcome of step 52. The component 3 may accept the sale if the data and the results of the other requirements associated with the sale satisfy a predetermined criteria. In one embodiment, the component 3 may reject the sale if the data and the results of other requirements do not satisfy the predetermined criteria. The other requirements may include a medical test, a physical exam and/or a type of annuity. At step 54, the component 3 may notify the customer of the acceptance or the rejection of the sale.

The new business dashboard 8 may be used to measure a throughput, a timeliness, a yield and a cost of effecting fulfillment of the new business. The substep of measuring the throughput may include measuring the amount of new business placed, revenue from the new business placed and a ratio of new business placed to all business pending customer decision.

The sub-step of measurement of the timeliness may include measuring a span from a time the consumer makes a purchase commitment to a time a product (or sales contract) is placed in force. A target time span may be based upon regulatory or other business requirements or objectives. In one embodiment, the timeliness may also be measured by measuring a span of time from a beginning of contractual payment terms to a time a payment is rendered. A target time span may be based upon contractual requirements.

The yield may be measured by measuring a selection ratio, a placement ratio, an attainment ratio, a commitment accuracy and a commission accuracy. The selection ratio may be measured for underwritten products by measuring the ratio of underwriting acceptance to a total number evaluated. The placement ratio may be measured by measuring a ratio of business placed by the customer to business accepted by the business entity 1. The attainment ratio may be measured by measuring a ratio of either revenue or the number placed to the production target in the new business development plan. The commitment accuracy may be measured by measuring the number of reissues in relation to the number placed. The commission accuracy may be measured by measuring the number of adjustments made in relation to an amount of commissions paid.

The costs of the new business processes may be measured by measuring costs per transaction. The costs per transaction may include all resources and costs associated with fulfilling new business, including application processing, case management, underwriting, evaluations, notification costs, issuance and delivery costs, receivable processing and all commissions.

FIG. 9 is a screen shot illustrating one embodiment of an output of the measurement module 98 with respect to the B2C new business processes. As shown in FIG. 9, the output of the measurement module 98 may include evaluation tools such as tables and charts. In the embodiment shown, the charts and tables may be used to compare different component 3's yields, timeliness, etc. in reference to targeting, contacting and selling.

FIG. 10 is a screen shot illustrating one embodiment of the output of the measurement module 98 with respect to the new business processes. As shown in FIG. 10, the output of the measurement module 98 may include charts and tables comparing different aspects of the new business obtained. In the embodiment shown, the yield and the timeliness with reference to different factories may be compared on charts. The throughput, the yield, and the timeliness are shown to be tabulated with respect to products by location.

The invention is related in one regard to the use of a computer system for delivering sales solutions in an insurance company. According to one embodiment of the invention, processing of new business data is provided via the computer system in response to a processor executing one or more sequences of one or more instructions contained in a main memory of the computer system.

Such instructions may be read into the main memory from another computer-readable medium, such as a storage device. Execution of a plurality of sequences of the instructions contained in the main memory causes the processor to perform the process steps described herein. One or more processors in a multi-processing arrangement may also be employed to execute the sequences of instructions contained in the main memory. In alternative embodiments, hard wired circuitry may be used in place of or in combination with a plurality of software instructions to implement the invention. Thus, embodiments of the invention are not limited to a specific combination of hardware circuitry and software.

The term “computer-readable medium” as used herein refers to any medium that participates in providing instructions to the processor for execution. Such a medium may take many forms, including but not limited to a non-volatile media, a volatile media, and a transmission media. The non-volatile media may include a dynamic memory, such as the main memory. The transmission media include coaxial cables, copper wire and fiber optics, including a plurality of wires that comprise a bus. The transmission media can also take the form of acoustic or light waves, such as those generated during radio frequency (RF) and infrared (IR) data communications. Common forms of computer-readable media include, for example, a floppy disk, a flexible disk, a hard disk, a magnetic tape, any other magnetic medium, a CD-ROM, a DVD, any other optical medium, punch cards, a paper tape, any other physical medium with patterns of holes, a random access memory (RAM), a programmable read-only memory (PROM), an erasable programmable read-only memory (EPROM), a FLASH-EPROM, any other memory chip or a cartridge, a carrier wave as described hereinafter, or any other medium from which a computer can read instructions for processing.

Various forms of computer readable media may be involved in carrying one or more sequences of one or more instructions to the processor for execution. For example, the instructions may initially be borne on a magnetic disk of a remote computer. The remote computer can load the instructions into its dynamic memory and send the instructions over a telephone line using a modem. A modem local to the computer system can receive the data on the telephone line and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on a storage device as described herein, either before or after execution by the processor.

The computer system also includes a communication interface coupled to the bus. The communication interface provides a two-way data communication coupling to a network link that is connected to a local or other network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links also may be implemented. In any such implementation, the communication interface sends and receives electrical, electromagnetic or optical signals that carry digital data streams representing various types of information.

The network link typically provides data communication through one or more networks to other data devices. For example, the network link may provide a connection through the local network to a host computer, a server or to other data equipment operated by an Internet Service Provider (ISP) or another entity. The ISP in turn provides data communication services through the world wide packet data communication network, now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), the network link, and the communication interface. In the Internet example, a server might transmit a requested code for an application program through the Internet, the ISP, the local network and the communication interface. In accordance with the invention, one such downloaded application provides for operating and maintaining the system described herein. The received code may be executed by the processor as it is received, and/or stored in the storage device, or other non-volatile storage for later execution. In this manner, the computer system may obtain application code via a carrier wave or other communications.

A process for delivery of new business solutions in components of a business entity is described. The new business solution delivery process is part of an overall process for conducting the operations of the component within the business entity. The overall process may include assessing the market, developing solutions, delivering solutions, servicing solutions and managing assets and liabilities.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A process for evaluating a business entity's success in developing new business, comprising the steps of:
(a) developing a strategy and a plan to support at least one of the business entity's high level objectives in a component of the business entity;
(b) establishing a relationship between the component of the business entity and an intermediary using the developed plan;
(c) establishing a relationship between the component of the business entity and a producer using the developed plan;
(d) establishing a relationship between the component of the business entity and a consumer using the developed plan; and
(e) processing new business resulting from the established relationships.

2. The process of claim 1 wherein the business entity comprises a first business and the component of the business entity comprises a second business acquired by the first business.

3. The process of claim 1 wherein the step of establishing a relationship between the component of the business entity and the consumer comprises the sub-steps of:
targeting at least one consumer;
establishing contact with the at least one consumer; and
selling a product to the at least one consumer.

4. The process of claim 3 wherein the sub-step of targeting the at least one consumer includes receiving the developed plan and outputting at least one identified qualified target consumer;
wherein the sub-step of establishing contact with the at least one identified qualified target consumer includes receiving input from the at least one identified qualified target consumer and outputting a response to the at least one identified qualified target consumer; and the sub-step of selling a product to the at least one consumer includes receiving the response outputted to the at least one identified qualified target consumer; and outputting a consumer decision.

5. The process of claim 1 further comprising the step of evaluating at least one of steps (b) to (e) to assess the success of the process of developing new business in the component of the business entity.

6. The process of claim 5 wherein the step of evaluating the at least one of steps (b) to (e) comprises the sub-steps of measuring at least one of a throughput, a timeliness, a yield, and a cost of developing the new business in the component of the business entity.

7. A system for evaluating a business entity's success in developing new business comprising:
(a) a deliver solutions module for evaluating one or more factors relating to a strategy and a plan to support at last one of the business entity's high level objectives in a component of the business entity;
(b) a business to business unit associated with the deliver solutions module for measuring one or more factors relating to a relationship between the component of the business entity and an intermediary using the developed plan;
(c) a business to producer unit associated with the deliver solutions module for measuring one or more factors relating to a relationship between the component of the business entity and a producer using the developed plan;
(d) a business to consumer unit associated with the deliver solutions module for measuring one or more factors relating to a relationship between the component and a consumer using the developed plan; and
(e) a new business unit associated with the deliver solutions module for measuring new business resulting from an established relationship between the component of the business entity and an intermediary, a producer and a consumer.

8. The system of claim 7 further comprising a measurement module for measuring at least one of a throughput, a timeliness, a yield and a cost of the deliver solutions module processes.

9. The system of claim 7 wherein the new business unit includes:
a target consumer module receiving the developed plan and outputting at least one identified qualified target consumer;
an establish contact module receiving an input from the at least one identified qualified target consumer and outputting a response to the at least one identified qualified target consumer; and
a sales module receiving a consumer decision.

10. A process for developing new business in a business entity including a plurality of components comprising the steps of:
(a) developing a strategy and a plan, in a deliver solutions module of the business entity, to support the business entity's high level objectives in a component of the business entity;
(b) implementing a business to business relationship between the component and an intermediary using the developed plan;
(c) implementing a business to producer relationship between the component and a producer using the developed plan;
(d) implementing a business to consumer relationship between the component and a consumer by performing a business to consumer sales process comprising the steps of:
(i) targeting a consumer for the component of the business entity,
(ii) establishing contact between the component of the business entity and the consumer, and
(iii) selling a product to the consumer; and
(e) using a new business unit of the deliver solutions module to measure new business resulting from the relationships implemented.

11. The process of claim 10 wherein the step of developing a strategy and a plan comprises the sub-step of maintaining the plan through a predetermined period of time.

12. The process of claim 10 wherein the step of developing a strategy and a plan comprises the sub-steps of:
performing a preparatory review of the developed plan;
proposing a plurality of goals;
mapping the goals to the business entity's high level objectives;
developing a plurality of strategies aligned with the goals;
developing at least one tactical plan based on the developed strategies;
confirming a capacity to perform the tactical plan(s);
developing a plurality of financial projections for the tactical plan(s);
communicating the tactical plan(s) to a plurality of channels and a plurality of factories within the business entity; and
maintaining and updating the tactical plan(s).

13. The process of claim 12 further comprising the step of ratifying the tactical plans with a plurality of stakeholders of the business entity.

14. The process of claim 10 wherein the step of implementing a business to business relationship comprises the sub-steps of:
assessing a universe of potential intermediaries;
selecting one or more target entities from the assessed potential intermediaries;
contacting the target entities;
developing a proposal for establishing a relationship with each of the target entities;
gaining a commitment to enter into a new relationship from at least one of the target entities;
implementing a new relationship with each of the committed target entities which does not have previous relationship with the business entity;
selling at least one new product to each of the committed target entities that have previous relationships with the business entity; and
managing the relationship with each of the committed target entities.

15. The process of claim 10 wherein the step of implementing a business to producer relationship comprises the sub-steps of:
engaging at least one of a non-captive producer of a product sold by the business entity and a captive-producer of a product sold by the business entity;
licensing and appointing each of the engaged producers;
performing one or more supporting functions to improve an effectiveness of each of the licensed and appointed engaged producers; and
managing the results of the business to producer relationships with each of the licensed and appointed engaged producers.

16. The process of claim 10 wherein the step of targeting the consumer comprises the sub-steps of:
identifying a source of consumers;
building models with filtering criteria for targeting consumers;
applying the models to the source of consumers; and
generating a list including at least one targeted consumer based on the application of the models to the source of the consumers.

17. The process of claim 10 wherein the step of establishing contact with the consumer comprises the sub-steps of:
developing a plurality of marketing tools to contact the consumer;
preparing to contact the consumer by developing and choosing specific marketing materials; and
initiating contact with the consumer.

18. The process of claim 10 wherein the step of initiating contact with the consumer comprises the sub-step of delivering an offer to the consumer.

19. The process of claim 10 wherein the step of selling a product to the consumer comprises the sub-steps of:
following through on the contact established with the consumer;
determining a plurality of needs of the consumer;
matching the needs of the consumer to a plurality of available products;
delivering a sales presentation to the consumer; and
closing a deal between the component and the consumer.

20. The process of claim 19 wherein the step of following through on the contact comprises the sub-step of setting up an appointment with the consumer.

21. The process of claim 10 wherein the step of implementing a business to consumer relationship between the component and the consumer comprises the sub-step of putting a purchase commitment from the consumer into force and collecting revenues resulting from a sale to the consumer.

22. The method of claim 10 wherein the step of implementing a business to consumer relationship between the component of the business entity and the consumer comprises the sub-steps of:
receiving and entering data related to a sale of a product;
consolidating results of other requirements for fulfillment of the sale of the product;
accepting the sale of the product if the data and the results of the other requirements associated with the sale of the product satisfy one or more predetermined criteria;
rejecting the sale of the product if the data and the results of the other requirements do not satisfy the predetermined criteria; and
notifying the consumer of an acceptance or a rejection of the sale of the product.

23. The process of claim 22 wherein the other requirements comprise at least one of a medical test, a physical exam, and a type of annuity.

24. The process of claim 10 wherein the step of implementing a business to consumer relationship between the component of the business entity and the consumer comprises at least one of a sub-step of processing an application, managing a case, underwriting an application, evaluating medical requirements, issuing a product, delivering the product, collecting revenues and reconciling an account.

25. The process of claim 10 wherein each of the business to business dashboard, the business to producer dashboard, the business to consumer dashboard and the new business dashboard comprise a web page.

26. The process of claim 10 further comprising the step of evaluating a plurality of new business development processes in the component of the business entity by using at least one of the business to business dashboard, the business to producer dashboard, the business to consumer dashboard and the new business dashboard.

27. The process of claim 10 further comprising the step of evaluating a plurality of the new business development processes in the component of the business entity by measuring a timeliness, a yield and a cost of the establishment of the business to business relationship using the business to business dashboard.

28. The process of claim 27 wherein the step of measuring the timeliness comprises measuring at least one of a number of first proposals generated in relation to a number of first proposals in progress in a proposal developing stage, a number of final dispositions in relation to a number of deals in progress in an obtaining an intermediary commitment stage, and an actual time span required for implementation of a new business relationship in relation to a time span defined by a contract date for implementation of a relationship in an implementing the business to business relationship stage.

29. The process of claim 27 wherein the step of measuring the yield comprises measuring at least one of a number of positive responses received from prioritized targets in relation to a number of prioritized targets in a contact targets stage, a number of first proposals which generated interest in implementing a new business relationship in contrast to a total number of first proposals generated in a proposal stage, a number of new business deals closed in relation to a total number of new business opportunities identified, an amount of revenues resulting from closed deals in relation to projected revenues in the new business development plan in an implement relationship stage, an amount of sales production costs in relation to an amount of projected sales production costs in the new business development plan in a managing the business to business relationship stage, a number of accounts closed during a predefined period in relation to a number of accounts existing at the start of the predefined period in the managing the relationship stage, and a sales penetration by intermediary in relation to the projected sales penetration in the new business development plan in the managing the relationship stage.

30. The process of claim 27 wherein the step of measuring costs comprises measuring a firm expense ratio including at least one of a plurality of manager salaries, a time and an expense of establishing of the business to business relationship, a cost of conducting due diligence meetings, a cost of implementing education and a cost of sales.

31. The process of claim 10 further comprising the step of evaluating the deliver solutions module processes in the component of the business entity by measuring a timeliness, a yield and a cost of enabling the business to producer relationship using the business to producer dashboard.

32. The process of claim 31 wherein the step of measuring timeliness comprises measuring at least one of a number of sales positions filled compared to a number of open sales positions for captive producer staffing in an engaging captive producers stage, a time from a point when a customer need is identified to a first sale generated by the captive producer, a time from a request to a notification of completion in a licensing and appointing producers stage, a speed of answer time including a time from an interactive voice response selection to an answer for all inquiries received through automated switches in a supporting producers stage, a resolution cycle time including a time from a first inquiry to a resolution and a closure with an originator for all support requests received in the supporting producers stage.

33. The process of claim 31 wherein the step of measuring yield comprises measuring at least one of a non-captive production by regional manager by product in relation to the developed plan in an engaging non-captive producers stage; a non-captive producer penetration in the engaging non-captive producers stage; a captive production by regional manager by product in relation to the developed plan in an engaging captive producers stage; a captive producer retention in the engaging captive producers stage; a number of incoming inquiries abandoned before a first response in relation to a total number of inquiries tendered in a supporting producers stage, and a number of inquiries resolved on a first inquiry in relation to a total number of inquiries in the supporting producers stage.

34. The process of claim 31 wherein the step of measuring costs comprises measuring an enabling expense ratio including at least one of a plurality of salaries and a plurality of bonuses paid to internal sales leaders, a plurality of bonuses paid to external sales agents and brokers, a time and an expense of enabling the business to producer relationship, the cost of sales producer education, the cost of development and distribution of marketing materials, the cost of home office support processes for field sales producers, a cost of licensing and appointment resources and fees, and a cost of technology and automation tools.

35. The process of claim 10 further comprising the step of evaluating the deliver solutions module processes in the component by measuring a timeliness, a yield and a cost of the establishment of the business to consumer relationship in the business to consumer dashboard.

36. The process of claim 35 wherein the step of measuring the timeliness comprises the sub-step of measuring at least one of a number of days between an actual start date and a planned start date in an establishing contact with the consumer stage, a time from a positive response from the consumer to a close of a sale in a sell to the consumer stage, a time from a positive response to a first presentation to the consumer in the sell to the consumer stage, a time from the first presentation to a second presentation in the sell to the consumer stage and a time from the second presentation to the close of the sale in the sell to consumer stage.

37. The process of claim 35 wherein the step of measuring the yield comprises the sub-step of measuring at least one of a response ratio in an establish contact with the consumer stage, a number of commitments obtained in relation to a number of positive responses in a sell to the consumer stage, a number of first presentation opportunities in relation to the number of positive responses in the sell to the consumer stage, a number of second presentation opportunities in relation to the number of first presentations in the sell to the consumer stage and the number of purchase commitments received in relation to the number of second presentations in the sell to the consumer stage.

38. The process of claim 35 wherein the step of measuring cost comprises the sub-step of measuring at least one of a cost per name, a cost per response, and a cost per sale.

39. The process of claim 38 wherein the step of measuring the throughput comprises measuring at least one of an amount of new business placed, revenues received from the new business placed, and a ratio of new business placed compared to all business pending consumer decision.

40. The process of claim 38 wherein the step of measuring the timeliness comprises measuring at least one of a time span from a time a consumer makes a purchase commitment to a time a product is put in force and a time span from a beginning of contractual payment terms to a time a payment is rendered.

41. The process of claim 38 wherein the step of measuring the yield comprises measuring at least one of a ratio of underwriting acceptance to a total evaluated, a ratio of new business placed by the consumer to an amount of new business accepted by the business entity, a ratio of an amount of new business placed to a sales production target committed to in the new business development plan, a ratio of revenues received from new business placed to the sales production target committed to in the new business development plan, a ratio of a number of re-issues to the amount of new business placed and a ratio of a number of adjustments to a number of commissions paid.

42. The process of claim 38 wherein the step of measuring the cost comprises measuring a cost per a transaction.

43. A system for developing new business in a business entity including a plurality of components comprising:
(a) a deliver solutions module for developing a strategy and a plan to support the business entity's high level objectives in a component of the business entity;
(b) a business to business dashboard associated with the deliver solutions module to establish a relationship between the component and an intermediary using the developed plan;
(c) a business to producer dashboard associated with the deliver solutions module to enable a relationship between the component and a producer using the developed plan;
(d) a business to consumer dashboard associated with the deliver solutions module to establish a relationship between the component and a consumer including:
(i) a consumer targeting module to target a consumer for the component of the business entity,
(ii) an establish contact module to establish contact between the component and the consumer, and
(iii) a sales module to sell a product to the consumer; and
(e) a new business dashboard of the deliver solutions module to process new business resulting from the relationship with the consumer within the component entity.

44. The system of claim 43 wherein each of the business to business dashboard, the business to producer dashboard, the business to consumer dashboard and the new business unit comprise a web page.

45. The system of claim 43 further comprising a measurement module for measuring a timeliness, a yield and a cost of the establishment of the business to business relationship in the business to business dashboard.

46. The system of claim 43 further comprising a measurement module for measuring a timeliness, a means for measuring yield and a means for measuring cost of enabling the business to producer relationship in the business to producer dashboard.

47. The system of claim 43 further comprising a measurement module for measuring timeliness, a means for measuring yield and a means for measuring cost of establishment of the business to consumer relationship in the business to consumer dashboard.

48. The system of claim 43 further comprising a measurement module for measuring a throughput, a means for measuring a timeliness, a means for measuring a yield and a means for measuring a cost of processing at least one new business relationship in the new business dashboard.

49. A system for evaluating a business entity's success in developing new business, wherein the business entity includes a plurality of components comprising:
(a) means for developing a strategy and a plan, in a deliver solutions module of the business entity, to support the business entity's high level objectives in a component of the business entity;
(b) means for establishing a relationship between the component of the business entity and an intermediary in the deliver solutions module using the developed plan;
(c) means for enabling a relationship between the component of the business entity and a producer in the deliver solutions module using the developed plan;
(d) means for establishing a relationship between the component of the business entity and a consumer in the deliver solutions module using the developed plan; and
(e) means for processing new business resulting from the established relationships in the deliver solutions module.

50. The system of claim 49 wherein the means for establishing a relationship between the component of the business entity and the consumer comprises:
means for targeting at least one consumer;
means for establishing contact with the at least one consumer; and
means for selling a product to the at least one consumer.

51. The system of claim 50 wherein the means for targeting the at least one consumer includes means for receiving the developed plan and means for outputting at least one identified qualified target consumer, the means for establishing contact with the at least one consumer includes means for receiving the at least one identified qualified target consumer and means for outputting a response from the at least one identified qualified target consumer, and the means for selling to the at least one consumer includes means for receiving the response from the at least one identified qualified target consumer and means for outputting a consumer decision.

52. The system of claim 49 further comprising means for evaluating at least one of steps (b) to (e) to assess the success of the process of developing new business in the component entity.

53. The system of claim 49 wherein the means for evaluating at least one of the steps (b) to (e) comprises means for measuring at least one of a throughput, a timeliness, a yield, and a cost of developing the new business in the component of the business entity.
